(19) United States
(12) Patent Application Publication
(10) Pub. No.: US 2015/0068443 A1
(43) Pub. Date: Mar. 12, 2015

(54) INSTRUMENT PANEL HAVING POINTER

(71) Applicants: Kia Motors Corporation, Seoul (KR); Hyundai Motor Company, Seoul (KR)

(72) Inventor: Ki Tae EOM, Hwaseong-si (KR)

(73) Assignees: KIA MOTORS CORPORATION, Seoul (KR); HYUNDAI MOTOR COMPANY, Seoul (KR)

(21) Appl. No.: 14/144,530

(22) Filed: Dec. 30, 2013

(30) Foreign Application Priority Data
Sep. 6, 2013 (KR) 10-2013-0107420

(51) Int. Cl. G01D 11/28

(52) U.S. Cl. CPC G01D 11/28
USPC 116/288

(57) ABSTRACT

An instrument panel having a pointer includes a pointer rotatably centered on a point to pass a numerical region. The pointer may include a transparent portion formed at the numerical region making the numerical region visible from outside of the instrument panel. A first color portion is formed on an outer end portion of the pointer so as to be seen in a first color, and a second color portion is formed on a center of the pointer so as to be seen in a second color.

### CROSS-REFERENCE TO RELATED APPLICATION

This application claims the benefit of priority to Korean Patent Application No. 10-2013-0107420 filed in the Korean Intellectual Property Office on Sep. 6, 2013, the entire contents of which are incorporated herein by reference.

### TECHNICAL FIELD

The present disclosure relates to an instrument panel having a pointer for notifying a driver of an operation state by means of a structure which improves visibility of the driver with a colored portion and a transparent portion.

### BACKGROUND

In general, instrument panels are mounted to a front of an instrument cluster on a front side of a vehicle where the driver sits for a driver to observe speed and RPM of the vehicle, water temperature, fuel quantity, and so on.

The present speed and RPM of the vehicle, the water temperature, the fuel quantity, and so on, shown on the instrument panels are made visible to the driver with pointers provided to respective instrument panels.

Each of the instrument panels has a light provided therein for the driver or a passenger to easily notice the present numerical values of respective pointers even at night.

FIG. 1 illustrates a schematic front view of an instrument panel having the related art pointer. Referring to FIG. 1, an instrument panel 130 has a pointer 100 disposed on the center of a rotation body 120.

The pointer 100, which indicates a numerical region 110, provides poor visibility because the pointer 100, which is non-transparent, covers the numerical region 110.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides an instrument panel having a pointer, which has an advantage of improved visibility. An aspect of the present disclosure provides an instrument panel having a pointer, in which a structure and a color of the pointer provide improved visibility of which indicates a numeral on a numerical region of the instrument panel.

According to an exemplary embodiment of the present disclosure, the instrument panel having a pointer rotatably centered on a point to pass a numerical region may include a transparent portion formed at the numerical region making the numerical region visible from an outside of the instrument panel. A first color portion is formed on an outer end portion of the pointer so as to be seen in a first color, and a second color portion is formed on a center of the pointer so as to be seen in a second color.

The transparent portion may have a fixed thickness.

The first color portion may have a first color layer formed on an outside surface thereof for producing the first color, and the second color portion may have a second color layer formed on an outside surface thereof for producing the second color.

The first color layer may include a first bottom color layer formed on a surface facing the numerical region, and a first upper color layer formed on a surface opposite to the first bottom color layer.

The second color layer may include a second bottom color layer formed on a surface facing the numerical region, and a second upper color layer formed on a surface opposite to the first bottom color layer.

The second color portion may gradually become thicker along a direction extending toward the point on which the pointer is rotatably centered.

The instrument panel having a pointer of the present disclosure improves visibility by forming a transparent portion at the pointer and maintaining a thickness of the transparent portion.

Formation of the color layers with foil on an underside and upper side of the pointer improves visibility. Further, the formation of a region having a first color on one side of the transparent portion and a region having a second color on the other side of the transparent portion of the pointer improves visibility.

### BRIEF DESCRIPTION OF THE DRAWINGS

FIG. 1 illustrates a schematic front view of an instrument panel having the related art pointer.

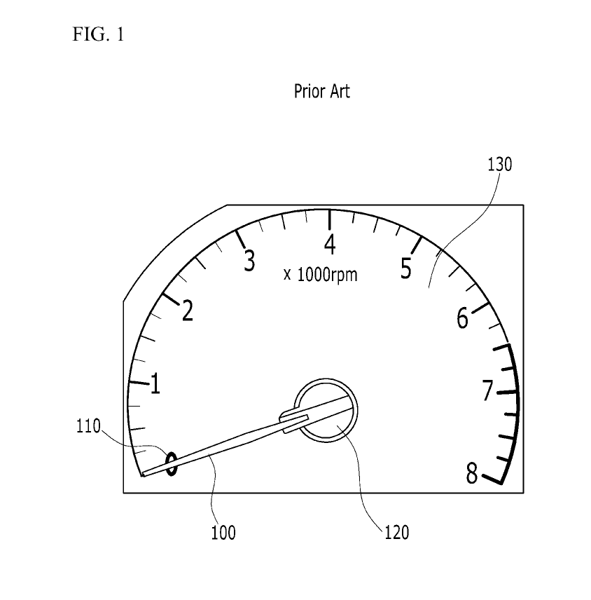

FIG. 2 schematically illustrates a partial front view of an instrument panel having a pointer in accordance with an exemplary embodiment of the present disclosure.

FIG. 3 illustrates a plan view of a pointer in accordance with an exemplary embodiment of the present disclosure.

FIG. 4 illustrates a cross sectional view of a pointer in accordance with an exemplary embodiment of the present disclosure.

FIG. 5 illustrates a cross sectional view of a pointer in accordance with another exemplary embodiment of the present disclosure.

FIG. 6 illustrates a schematic partial side view of a device for forming a color layer on a pointer in accordance with an exemplary embodiment of the present disclosure.

### DETAILED DESCRIPTION

An exemplary embodiment of the present disclosure will hereinafter be described in detail with reference to the accompanying drawings.

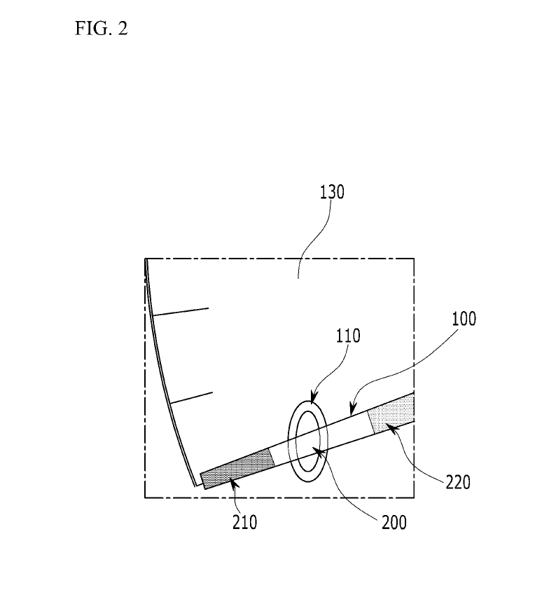

FIG. 2 illustrates a schematic partial front view of an instrument panel having a pointer in accordance with an exemplary embodiment of the present disclosure. Referring to FIG. 2, an instrument panel 130 having a pointer 100 includes a numerical region 110 having numerals formed thereon, a first color portion 210, a transparent portion 200, and a second color portion 220.

The transparent portion 200 is transparent so that numerals formed at the numerical region 110 can be seen. The first color portion 210 produces a red color, and the second color portion 220 produces a blue color.

The first color portion 210 and the second color portion 220 improve visibility of a driver, and the numerals are visible through the transparent portion.

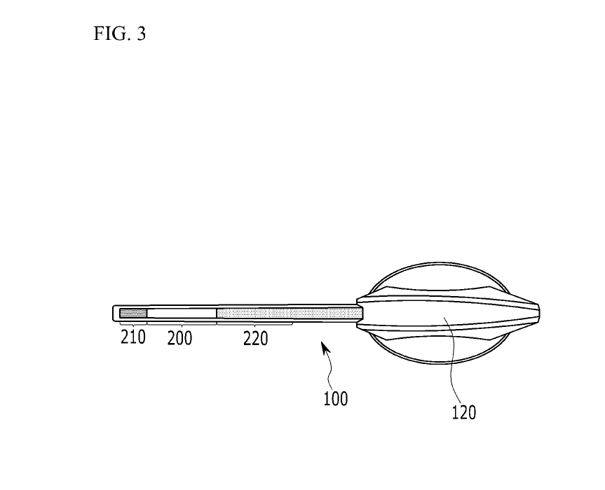

FIG. 3 illustrates a plan view of a pointer in accordance with an exemplary embodiment of the present disclosure. Referring to FIG. 3, the pointer 100 includes a rotation body 120 formed at a rotation center, and the second color portion 220, the transparent portion 200, and the first color portion 210 which extend from the rotation body 120. The second color portion 220, the transparent portion 200, and the first color portion 210 may be formed as one unit. In certain embodiments, the first color portion, which produces a first color; and the second color portion 220, which produces a second color; may be formed of foil or paint.

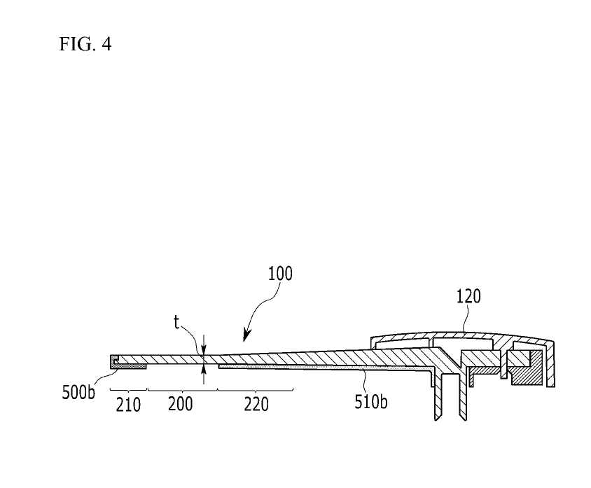

FIG. 4 illustrates a cross sectional view of a pointer in accordance with an exemplary embodiment of the present disclosure. Referring to FIG. 4, the transparent portion 200 of the pointer 100 has a fixed thickness t. Accordingly, the numeral seen through the transparent portion 200 is not distorted, thereby improving visibility to the driver. The pointer 100 has a first bottom color layer 500b formed on an underside of the first color portion 210 facing the numerical region for producing the first color, and a second bottom color layer 510b formed on an underside of the second color portion 220 facing the numerical region for producing the second color.

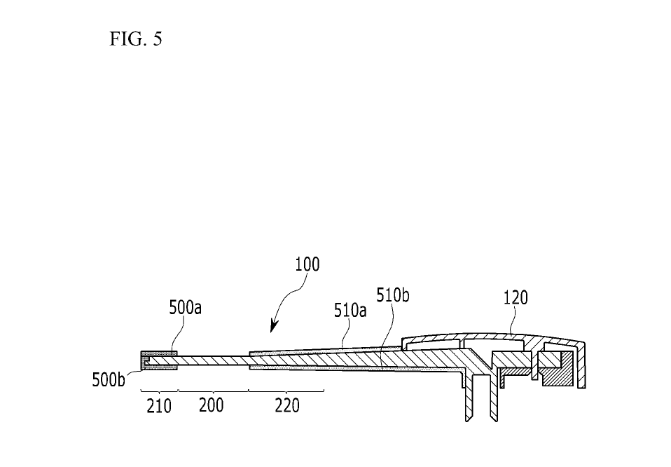

FIG. 5 illustrates a cross sectional view of a pointer in accordance with another exemplary embodiment of the present disclosure. Referring to FIG. 5, the pointer 100 includes a first color portion 210 having a first bottom color layer 500b and a first upper color layer 500a formed on an underside and an upper side of the first color portion 210 for producing the first color, respectively. A second color portion 220 has a second bottom color layer 510b and a second upper color layer 510a formed on an underside and an upper side of the second color portion 220 for producing the second color, respectively.

The second color portion 220 has a structure in which the second color portion 220 becomes gradually thicker as the second color portion moves toward a rotation body 120.

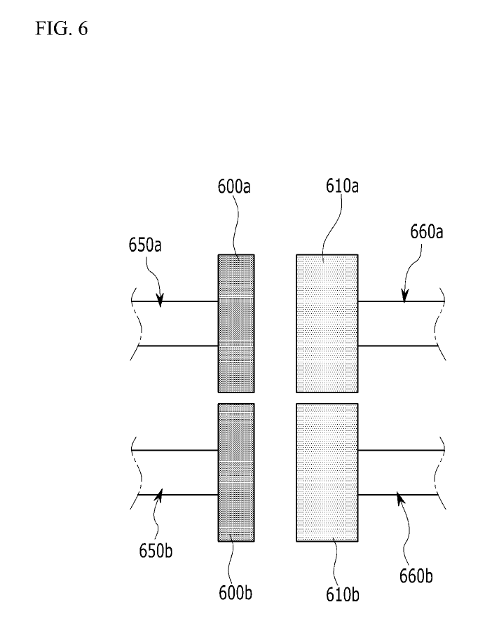

FIG. 6 illustrates a schematic partial side view of a device for forming a color layer on a pointer in accordance with an exemplary embodiment of the present disclosure. Referring to FIG. 6, a device for forming a color layer on a pointer includes a first upper roller 650a, a first bottom roller 650b, a second upper roller 660a, and a second bottom roller 660b.

The first upper roller 650a has an end portion with a first upper foil 600a wound thereon, and the first bottom roller 650b has an end portion with a first bottom foil 600b wound thereon. The second upper roller 660a has an end portion with a second upper foil 610a wound thereon, and the second bottom roller 660b has an end portion with a second bottom foil 610b wound thereon.

Referring to FIGS. 5 and 6, the first bottom foil 600b is attached to an underside of the first color portion 210 of the pointer 100 to form the first bottom color layer 500b. The first upper foil 600a is attached to an upper side of the first color portion 210 of the pointer 100 to form the first upper color layer 500a. The second bottom foil 610b is attached to an underside of the second color portion 220 of the pointer 100 to form the second bottom color layer 510b, and the second upper foil 610a is attached to an upper side of the second color portion 220 of the pointer 100 to form the second upper color layer 510a.

In an exemplary embodiment of the present disclosure, the first bottom color layer 500b and the first upper color layer 500a produce a red color, and the second bottom color layer 510b and the second upper color layer 510a produce a blue color.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. In an instrument panel having a pointer rotatably centered on a point to pass a numerical region, the pointer comprising:
a transparent portion formed at the numerical region making the numerical region visible from outside of the instrument panel;
a first color portion formed on an outer end portion of the pointer so as to be seen in a first color; and
a second color portion formed on a center of the pointer so as to be seen in a second color.

2. The instrument panel having a pointer of claim 1, wherein the transparent portion has a fixed thickness.

3. The instrument panel having a pointer of claim 1, wherein the first color portion has a first color layer formed on an outside surface thereof for producing the first color, and the second color portion has a second color layer formed on an outside surface thereof for producing the second color.

4. The instrument panel having a pointer of claim 3, wherein the first color layer includes:
a first bottom color layer formed on a surface facing the numerical region; and
a first upper color layer formed on a surface opposite to the first bottom color layer.

5. The instrument panel having a pointer of claim 3, wherein the second color layer includes:
a second bottom color layer formed on a surface facing the numerical region; and
a second upper color layer formed on a surface opposite to the first bottom color layer.

6. The instrument panel having a pointer of claim 1, wherein the second color portion gradually becomes thicker along a direction extending toward the point on which the pointer is rotatably centered.
